(19) United States
(12) Patent Application Publication
(10) Pub. No.: US 2013/0044142 A1
(43) Pub. Date: Feb. 21, 2013

(54) METHOD OF DRIVING A PIXEL AND A SYSTEM FOR THE SAME

(71) Applicant: Chihtsung Kang, Shenzhen (CN)

(72) Inventor: Chihtsung Kang, Shenzhen (CN)

(73) Assignee: SHENZHEN CHINA STAR OPTOELECTRONICS TECHNOLOGY CO., LTD., Shenzhen (CN)

(21) Appl. No.: 13/318,781

(22) PCT Filed: Aug. 29, 2011
(86) PCT No.: PCT/CN11/79043

§ 371 Date: Nov. 4, 2011

(30) Foreign Application Priority Data
Aug. 15, 2011 (CN) 201110233086.9

(51) Int. Cl. G09G 3/36; G09G 5/10

(52) U.S. Cl. 345/690; 345/89

(57) ABSTRACT

The present invention provides a method of driving pixels of an LCD including step (S1) converting one image signal of a frame to two image signals of a frame, and the two image signals both comprise main gray-level signals; the step S2 which is making one of the two image signals display main gray-level signals via a main sub-pixel and the other of the two image signals display main gray-level signals via a secondary sub-pixel. The present invention also relates to a pixel driving system. The present invention provides enough time for the main and secondary sub-pixels of each frame to display main gray-level signals to optimize image resolution by changing driving signals of the main and secondary sub-pixels.

### BACKGROUND OF THE INVENTION

1. Field of the Invention

The present invention relates to a liquid crystal display (LCD), and more particularly, to a method of driving pixels of the LCD capable of upgrading resolutions and a system for the same.

2. Description of the Prior Art

The objective of improvement in color washout of a pixel driving structure in the prior art is achieved by separating one pixel into two sub-pixels, one is a main sub-pixel and the other one is a secondary sub-pixel, and further by combining different optical characteristics which is realized by different driving voltages applying on the two pixels. For instance, FIG. 1 shows light intensity relationship between a front view and a side view of an LCD not utilizing the main and secondary sub-pixel structure. FIG. 2 shows light intensity relationship between a front view and a side view of an LCD utilizing main and secondary sub-pixel structure. In FIG. 2, a curve A depicts a light intensity at a side view of the main sub-pixel, a curve B depicts a=light intensity at a side view of the secondary sub-pixel, and a curve C depicts a light intensity at a side view of the mix of the main and the secondary sub-pixels. It is understood that the C curve which applies the main and secondary sub-pixels is more analogous to an ideal curve D depicting light intensity at a front view. Therefore, the improvement in color washout is made.

There are two types of main and secondary sub-pixel structures. One is named as a capacitor/capacitor (CC) type, and the other is named as a transistor/transistor (TT) type. For the CC type, the main and secondary sub-pixels driven by different driving voltages is realized by adjusting a ratio of a liquid crystal capacitor and a capacitor coupling between the main and secondary sub-pixels. For the TT type, the main and secondary sub-pixels are driven by different driving voltages from different data lines or scan lines. A disadvantage of the CC type is that the driving voltages applied on the main and secondary sub-pixels always depend on the capacitor coupling between the main and secondary sub-pixels, incapable of dynamically adjusting the driving voltage. In addition, the main sub-pixel and the secondary sub-pixel are dependent due to the capacitor coupling therebetween, leading to showing yellow with red phenomenon. The TT type, however, is capable of adjusting driving voltages to the main sub-pixel and secondary sub-pixels at will by transmitting different driving voltages to the main and secondary sub-pixels via different data lines or by using different scan lines to change charge time of the main and secondary sub-pixels. Furthermore, there is no yellow with red phenomenon because main sub-pixels and secondary sub-pixels are independent with each other. Thus, the improvement in color washout is better.

The TT type is realized by a 1G2D structure (in which each pixel is driven by a scan line and two data lines).

FIG. 3 shows a structure diagram of a 1G2D pixel. The pixel in FIG. 3 is separated into two sub-pixels. A main sub-pixel A2 comprises a transistor a2 of which a drain is coupled to a capacitor Csm and a liquid crystal capacitor Clm. A secondary sub-pixel B2 comprises a transistor b2 of which a drain is coupled to a capacitor Css and a liquid crystal capacitor Cls. A source of the transistor a2 is coupled to the data line Dqm. A source of the transistor b2 is coupled to the data line Dqs. The main sub-pixel A2 and the secondary sub-pixel B2 shares a scan line which is connected to a gate of the transistor a2 and a gate of the transistor b2.

When the pixel complying with 1G2D structure shows a medium or low gray level, the main sub-pixel showing a main gray-level signal (light state) while the secondary sub-pixel showing a secondary gray-level signal (dark state) or not showing any gray-level signal leads to the pixel larger in vision, and thus image resolution reduces.

Therefore, it is necessary to provide a method of driving a pixel and a system for the same to solve the problems in the prior art.

### SUMMARY OF THE INVENTION

The present invention provides a method and a system of driving a pixel to optimize image resolution by changing driving signals applied on the main and secondary sub-pixels to improve a defect of reduction of image resolution caused by the main sub-pixels displaying main gray-level signals and the secondary sub-pixels displaying secondary gray-level signals in the display of some pixels.

According to the present invention, a method of driving a pixel, is provided. The method comprises steps of: (S1) converting one image signal of a frame to two image signals of the frame, and each of the two image signals comprising a main gray-level signal; (S2) a main sub-pixel displaying the main gray-level signal of one of the two image signals, while a secondary sub-pixel displaying the main gray-level signal of the other image signal. When taking a pixel driven by a scan line and two data lines, each of the two image signals comprises a secondary gray-level signal, and a gray-level of the main gray-level signal is higher than that of the secondary gray-level signal. The step S2 comprises the step of: transmitting the main grey-level signal and the secondary grey-level signal of one of the two image signals to the main sub-pixel and the secondary sub-pixel, respectively; transmitting the main grey-level signal and the secondary grey-level signal of the other image signal to the secondary sub-pixel and the main sub-pixel, respectively. A time which the main sub-pixel displays main gray-level signal is equal to a time which the secondary sub-pixel displays secondary gray-level signal.

According to the present invention, a method of driving a pixel, is provided. The method comprises steps of: (S1) converting one image signal of a frame to two image signals of the frame, and each of the two image signals comprising a main gray-level signal; (S2) a main sub-pixel displaying the main gray-level signal of one of the two image signals, while a secondary sub-pixel displaying the main gray-level signal of the other image signal.

In one aspect of the present invention, when taking a pixel driven by a scan line and two data lines, each of the two image signals comprises a secondary gray-level signal, and a gray-level of the main gray-level signal is higher than that of the secondary gray-level signal; and the step S2 comprises the step of: transmitting the main grey-level signal and the secondary grey-level signal of one of the two image signals to the main sub-pixel and the secondary sub-pixel, respectively; transmitting the main grey-level signal and the secondary grey-level signal of the other image signal to the secondary sub-pixel and the main sub-pixel, respectively.

In one aspect of the present invention, the time which the main sub-pixel displays main gray-level signal is equal to the time which the secondary sub-pixel displays secondary gray-level signal.

In one aspect of the present invention, the step S1 comprises the step of converting the one image signal of the frame into a first image signal and a second image signal of the frame; the step S2 comprises the step of the secondary sub-pixel displays the main gray-level signal during displaying the first image signal; the main sub-pixel displays the main gray-level signal during displaying the second image signal.

In one aspect of the present invention, the step S2 further comprises the step of: the main sub-pixel displays the secondary gray-level signal during displaying the first image signal; the secondary sub-pixel displays the secondary gray-level signal during displaying the second image signal.

In one aspect of the present invention, when the main sub-pixel is electrically coupled to the scan line and a first data line, and the secondary sub-pixel is electrically coupled to the scan line and a second data line, the step S2 comprises the steps of: during displaying the first image signal, the main sub-pixel displays the secondary grey-level signal transmitted by the first data line, and the secondary sub-pixel displays the main gray-level signal transmitted by the second data line; during displaying the second image signal, the main sub-pixel displays the main gray-level signal transmitted by the first data line, and the secondary sub-pixel displays the secondary gray-level signal transmitted by the second data line.

In one aspect of the present invention, the step S1 comprises the step of converting the one image signal of the frame into a first image signal and a second image signal of the frame;

the step S2 comprises the step of the secondary sub-pixel displays the main gray-level signal during displaying the second image signal; the main sub-pixel displays the main gray-level signal during displaying the first image signal.

9. The method of claim 3, characterized in that:

the step S2 further comprises the step of: the main sub-pixel displays the secondary gray-level signal during displaying the second image signal; the secondary sub-pixel displays the secondary gray-level signal during displaying the first image signal.

In one aspect of the present invention, when the main sub-pixel is electrically coupled to the scan line and a first data line, and the secondary sub-pixel is electrically coupled to the scan line and a second data line, the step S2 comprises the steps of: during displaying the first image signal, the main sub-pixel displays the main grey-level signal transmitted by the first data line, and the secondary sub-pixel displays the secondary gray-level signal transmitted by the second data line; during displaying the second image signal, the main sub-pixel displays the secondary gray-level signal transmitted by the first data line, and the secondary sub-pixel displays the main gray-level signal transmitted by the second data line.

According to the present invention, the pixel driving system comprises: a conversion module, for converting one image signal of a frame to two image signals of the frame, and each of the two image signals comprising a main gray-level signal; and a display module, for displaying the main gray-level signal of one of the two image signals by using a main sub-pixel, while displaying the main gray-level signal of the other image signal by using a secondary sub-pixel.

In one aspect of the present invention, when taking a pixel driven by a scan line and two data lines, each of the two image signals comprises a secondary gray-level signal, and a gray-level of the main gray-level signal is higher than that of the secondary gray-level signal; and the display module is used for transmitting the main grey-level signal and the secondary grey-level signal of one of the two image signals to the main sub-pixel and the secondary sub-pixel, respectively, and for transmitting the main grey-level signal and the secondary grey-level signal of the other image signal to the secondary sub-pixel and the main sub-pixel, respectively.

In one aspect of the present invention the time which the main sub-pixel displays main gray-level signal is equal to the time which the secondary sub-pixel displays secondary gray-level signal.

The method of driving a pixel and the system for the same in the present invention propose that the main sub-pixel and the secondary sub-pixel can display main gray-level signals by changing the driving signals applied on the main sub-pixel and secondary sub-pixel in a frame time period. It would prevent from the defect of reduction of image resolution in the prior art resulting from the reason that the main sub-pixels displays the main gray-level signal while the secondary sub-pixels displays secondary gray-level signal in the frame time period.

These and other features, aspects and advantages of the present disclosure will become understood with reference to the following description, appended claims and accompanying figures.

### BRIEF DESCRIPTION OF THE DRAWINGS

FIG. 1 shows light intensity relationship between a front view and a side view of an LCD not utilizing the main and secondary sub-pixel structure.

FIG. 2 shows light intensity relationship between a front view and a side view of an LCD utilizing main and secondary sub-pixel structure.

FIG. 3 shows a structure diagram of a 1G2D pixel.

FIG. 4 shows a flow diagram of a method of driving pixel according to a preferred embodiment of the present invention.

FIG. 5 shows a structure diagram of a pixel driving system according to a preferred embodiment of the present invention.

FIG. 6 shows a flow diagram of a method of driving pixel according to another preferred embodiment of the present invention.

FIG. 7 illustrates a pixel structure of a Polymer Stabilized Vertical Alignment (PSVA) LCD

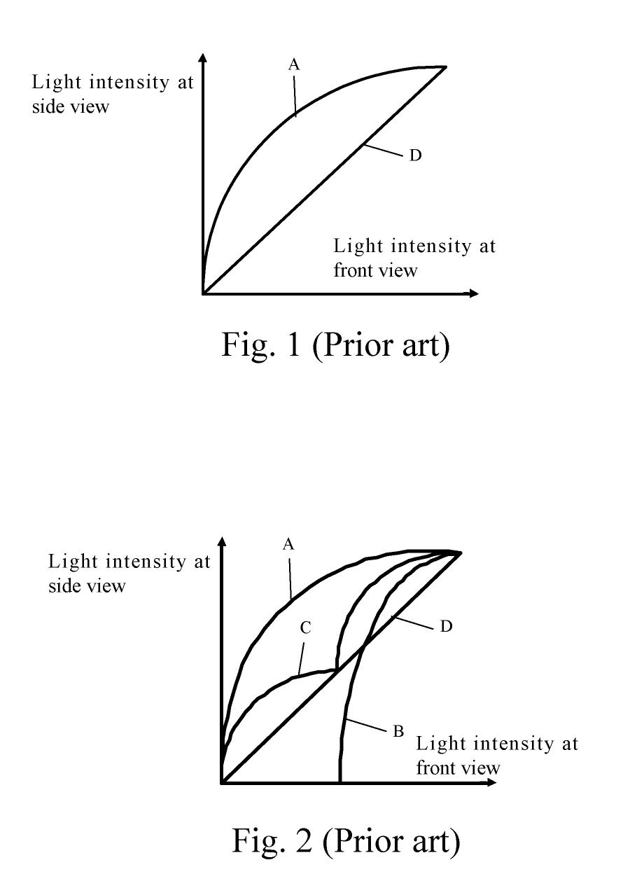

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

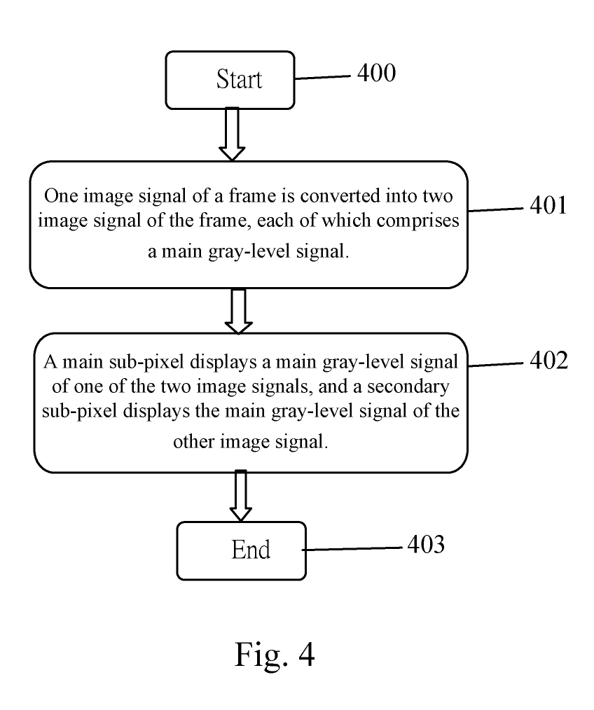

In the following disclosure, units having similar function are labeled as the same number. FIG. 4 shows a flow diagram of a method of driving pixel according to a preferred embodiment of the present invention. The method starts from step 400 and comprises following steps:

Step 401: converting one image signal of a frame into two image signal of the frame, each of which comprises a main gray-level signal;

Step 402: A main sub-pixel displays a main gray-level signal of one of the two image signals, and a secondary sub-pixel displays the main gray-level signal of the other image signal;

The method ends at Step 403.

The method of driving a pixel is to convert one image signal of a frame into two image signals of a frame so that the image signal of the same frame can adopt different driving methods. And then, a main sub-pixel displays a main gray-level signal of one of the two image signals via while a secondary sub-pixel displays a main gray-level signal of the other of the two image signals.

In the time period of displaying one image signal, the main sub-pixel is charged a voltage V1, and the light intensity normalization value of the main sub-pixel is L1. In the meantime, the secondary sub-pixel is charged a voltage V2 or none, and the light intensity normalization value of whole the main and secondary sub-pixels is L2. In the time period of displaying the other image signal, the secondary sub-pixel is charged a voltage V3, and the light intensity normalization value of a secondary sub-pixel is L1 while the main sub-pixel is charged a voltage V4 or none, and the light intensity normalization value of whole main and secondary sub-pixel is L2.

In order to make the light intensity normalization value of only driving the main sub-pixel equals to the light intensity normalization value of only driving secondary sub-pixel, the voltage V1 and voltage V3 are adjustable depending on the electrodes of the main sub-pixel and the secondary sub-pixel in size and the capacitor between the main and secondary sub-pixel. On the other hand, in order to make the light intensity normalization value of simultaneously driving the main sub-pixel and the secondary sub-pixel of the pixel which is dominated by the main sun-pixel equals to the light intensity normalization value of simultaneously driving the main sub-pixel and the secondary sub-pixel of the pixel which is dominated by the secondary sub-pixel, the voltage V2 and voltage V4 are adjustable depending on the electrodes of the main sub-pixel and the secondary sub-pixel in size and the capacitor between the main and secondary sub-pixel.

It keeps the whole light intensity of the two converted image signals unchanged, but the main and secondary sub-pixels can alternatively display the main gray level of the two converted image signals, so that the main sub-pixel is lighter and the secondary sub-pixel is darker in vision when the pixel is assigned to show a low gray level. Accordingly, the phenomenon of the larger pixels in vision which leads to reduction of image resolution is improved.

As a preferred embodiment of the method of driving the pixel according to the present invention, when taking the pixel structure of 1G2D, each of the two image signals comprises a secondary gray-level signal. A gray-level of the main gray-level signal is higher that of the secondary gray-level signal. In the step S2, the main gray-level signal of one of the two image signal is transmitted to the main sub-pixel, while the secondary gray-level signal of the image signal is transmitted to the secondary sub-pixel; the main gray-level signal of the other image signal is transmitted to the secondary sub-pixel, while the secondary gray-level signal of the other image signal is transmitted to the main sub-pixel.

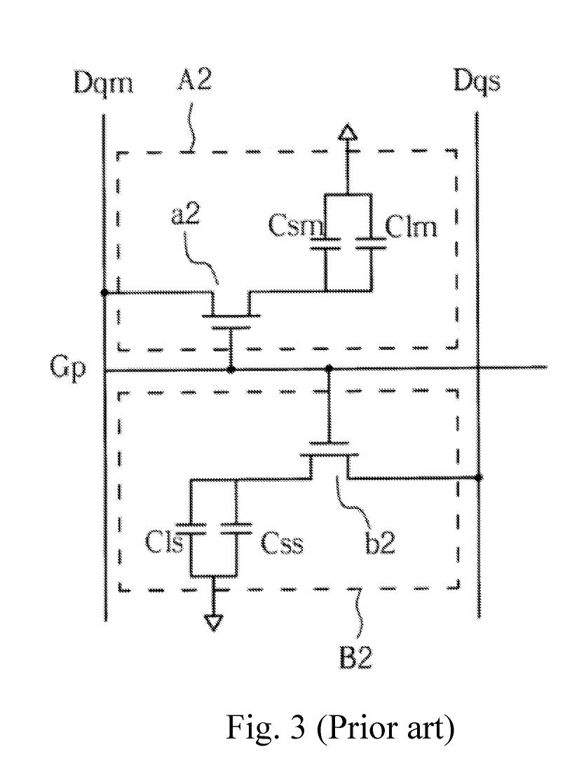

As shown in FIG. 3, a 1G2D-based pixel is driven by a scan line and two data lines. In the time period of displaying one of the image signal, the data line Dqm transmits a main gray-level signal, which makes the main sub-pixel A2 display a main gray-level signal, to the main sub-pixel A2 while the data line Dqs transmits a secondary gray-level signal, which makes the secondary sub-pixel B2 display a secondary gray-level signal, to the secondary sub-pixel B2. In a result, this frame indicates a display frame which is dominated by the main sub-pixel A2. In the time period of displaying the other image signal, the data line Dqs transmits a main gray-level signal, which makes the secondary sub-pixel B2 display a main gray-level signal, to the secondary sub-pixel B2 while the data line Dqm transmits a secondary gray-level signal, which makes the main sub-pixel A2 display a secondary gray-level signal, to the main sub-pixel A2. In a result, this frame indicates a display frame which is dominated by the secondary sub-pixel B2. The whole light intensity normalization value of the two converted frames through the arrangement of relative parameters (such as the capacitor Csm, a transistor Css, a liquid crystal capacitor Clm and a liquid crystal capacitor Cls) is capable of improving the reduction of image resolution caused by that the pixels becomes larger in vision under the circumstance that the main sub-pixel is lighter and the secondary sub-pixel is darker in the low gray level.

As a preferred embodiment of the method of driving a pixel, the time which the main sub-pixel displays the main gray-level signal is equal to the time which the secondary sub-pixel displays secondary gray-level signal. In a result, it is capable of stabilizing the whole light intensity normalization value of the whole pixel better to make the light intensity of the frame corresponding to the main gray-level signal displayed by the main sub-pixel equal to that of the main gray-level signal displayed by the secondary sub-pixel.

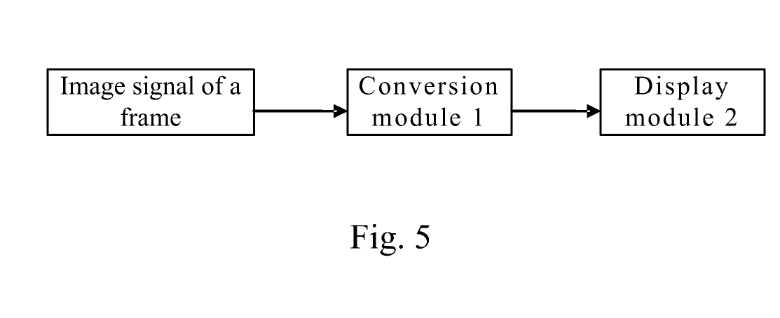

The present invention also relates to a pixel driving system. Please refer to FIG. 5, FIG. 5 shows a structure diagram of a pixel driving system according to a preferred embodiment of the present invention. The pixel driving system comprises a conversion module 1 and a display module 2. The conversion module 1 is used for converting an image signal of a frame into two image signals of a frame. Each of the two image signals comprises main gray-level signals. The display module 2 is used for making the main sub-pixel display a main gray-level signal of one of the two image signals, and making the secondary sub-pixel display the main gray-level signal of the other image signal.

The conversion module 1 of the pixel driving system is to convert one image signal of a frame into two image signals of the frame so that the image signal of the same frame can adopt different driving methods. And then, the display module 2 performs the operation that a main sub-pixel displays a main gray-level signal of one of the two image signals via while a secondary sub-pixel displays a main gray-level signal of the other image signals.

In the time period of displaying one image signal, the main sub-pixel is charged a voltage V1, and the light intensity normalization value of the main sub-pixel is L1. In the meantime, the secondary sub-pixel is charged a voltage V2 or none, and the light intensity normalization value of whole the main and secondary sub-pixels is L2. In the time period of displaying the other image signal, the secondary sub-pixel is charged a voltage V3, and the light intensity normalization value of a secondary sub-pixel is L1 while the main sub-pixel is charged a voltage V4 or none, and the light intensity normalization value of whole main and secondary sub-pixel is L2.

In order to make the light intensity normalization value of only driving the main sub-pixel equals to the light intensity normalization value of only driving secondary sub-pixel, the voltage V1 and voltage V3 are adjustable depending on the electrodes of the main sub-pixel and the secondary sub-pixel in size and the capacitor between the main and secondary sub-pixel. On the other hand, in order to make the light intensity normalization value of simultaneously driving the sub-pixel and the secondary sub-pixel of the pixel which is dominated by the main sun-pixel equals to the light intensity normalization value of simultaneously driving the main sub-pixel and the secondary sub-pixel of the pixel which is dominated by the secondary sub-pixel, the voltage V2 and voltage V4 are adjustable depending on the electrodes of the main sub-pixel and the secondary sub-pixel in size and the capacitor between the main and secondary sub-pixel.

It keeps the whole light intensity of the two converted image signals unchanged, but the main and secondary sub-pixels can alternatively display the main gray level of the two converted image signals, so that the main sub-pixel is lighter and the secondary sub-pixel is darker in vision when the pixel is assigned to show a low gray level. Accordingly, the phenomenon of the larger pixels in vision which leads to reduction of image resolution is improved.

As a preferred embodiment of the pixel driving system according to the present invention, when taking the pixel structure of 1G2D, each of the two image signals comprises a secondary gray-level signal. A gray-level of the main gray-level signal is higher that of the secondary gray-level signal. The display module 2 is used for performing the operation that the main gray-level signal of one of the two image signal is transmitted to the main sub-pixel, while the secondary gray-level signal of the image signal is transmitted to the secondary sub-pixel; the main gray-level signal of the other image signal is transmitted to the secondary sub-pixel, while the secondary gray-level signal of the other image signal is transmitted to the main sub-pixel.

As shown in FIG. 3, a 1G2D-based pixel is driven by a scan line and two data lines. In the time period of displaying one of the image signal, the data line Dqm transmits a main gray-level signal, which makes the main sub-pixel A2 display a main gray-level signal, to the main sub-pixel A2 while the data line Dqs transmits a secondary gray-level signal, which makes the secondary sub-pixel B2 display a secondary gray-level signal, to the secondary sub-pixel B2. In a result, this frame indicates a display frame which is dominated by the main sub-pixel A2. In the time period of displaying the other image signal, the data line Dqs transmits a main gray-level signal, which makes the secondary sub-pixel B2 display a main gray-level signal, to the secondary sub-pixel B2 while the data line Dqm transmits a secondary gray-level signal, which makes the main sub-pixel A2 display a secondary gray-level signal, to the main sub-pixel A2. In a result, this frame indicates a display frame which is dominated by the secondary sub-pixel B2. The whole light intensity normalization value of the two converted frames through the arrangement of relative parameters (such as the capacitor Csm, a transistor Css, a liquid crystal capacitor Clm and a liquid crystal capacitor Cls) is capable of improving the reduction of image resolution caused by that the pixels becomes larger in vision under the circumstance that the main sub-pixel is lighter and the secondary sub-pixel is darker in the low gray level.

As a preferred embodiment of the pixel driving system, the time which the main sub-pixel displays the main gray-level signal is equal to the time which the secondary sub-pixel displays secondary gray-level signal. In a result, it is capable of stabilizing the whole light intensity normalization value of the whole pixel better to make the light intensity of the frame corresponding to the main gray-level signal displayed by the main sub-pixel equal to that of the main gray-level signal displayed by the secondary sub-pixel.

The present invention also relates to a method of driving a pixel. The pixel comprises a main sub-pixel and a secondary sub-pixel. As shown in FIG. 7 illustrating a pixel structure of a Polymer Stabilized Vertical Alignment (PSVA) liquid crystal display (LCD), a pixel is shown. The pixel is divided into two portions, one is a main sub-pixel and the other is a secondary sub-pixel.

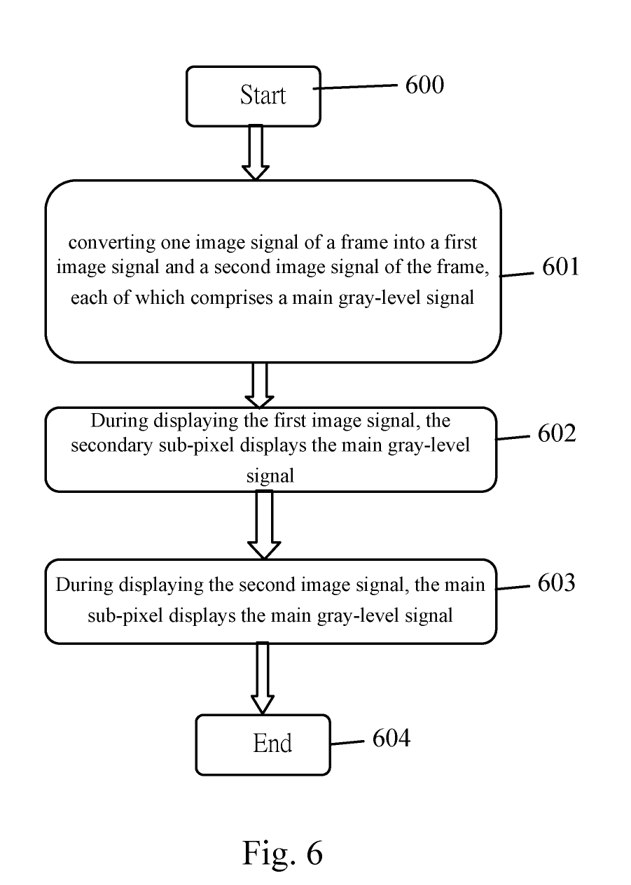

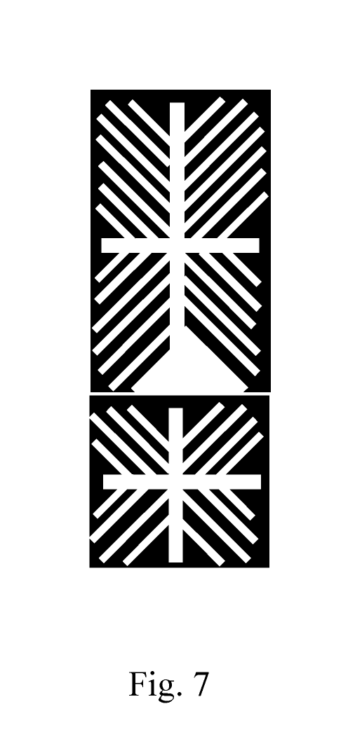

FIG. 6 shows a flow diagram of a method of driving pixel according to another preferred embodiment of the present invention. The method starts from step 600 and comprises following steps:

Step 601: converting one image signal of a frame into a first image signal and a second image signal of the frame, each of which comprises a main gray-level signal;

Step 602: During displaying the first image signal, the secondary sub-pixel displays the main gray-level signal;

Step 603: During displaying the second image signal, the main sub-pixel displays the main gray-level signal;

The method ends at Step 604.

Using a 1G2D-based pixel structure, each of the first and the second image signals comprises a secondary gray-level signal. A gray-level of the main gray-level signal is higher than that of the secondary gray-level signal. The secondary sub-pixel displays the main gray-level signal during displaying the first image signal. The main sub-pixel displays the main gray-level signal during displaying the second image signal. The main sub-pixel is electrically coupled to a scan line and a first data line, and the secondary sub-pixel is electrically coupled to the scan line and a second data line. During displaying the first image signal, the main sub-pixel displays the secondary grey-level signal transmitted by the first data line, and the secondary sub-pixel displays the main gray-level signal transmitted by the second data line. During displaying the second image signal, the main sub-pixel displays the main gray-level signal transmitted by the first data line, and the secondary sub-pixel displays the secondary gray-level signal transmitted by the second data line.

In another embodiment of the present invention, the secondary sub-pixel displays the main gray-level signal during displaying the second image signal. The main sub-pixel displays the main gray-level signal during displaying the first image signal.

Using a 1G2D-based pixel structure, each of the first and the second image signals comprises a secondary gray-level signal. A gray-level of the main gray-level signal is higher than that of the secondary gray-level signal. The main sub-pixel displays the secondary gray-level signal during displaying the second image signal; the secondary sub-pixel displays the secondary gray-level signal during displaying the first image signal. The main sub-pixel is electrically coupled to the scan line and a first data line, and the secondary sub-pixel is electrically coupled to the scan line and a second data line. During displaying the first image signal, the main sub-pixel displays the main grey-level signal transmitted by the first data line, and the secondary sub-pixel displays the secondary gray-level signal transmitted by the second data line. During displaying the second image signal, the main sub-pixel displays the secondary gray-level signal transmitted by the first data line, and the secondary sub-pixel displays the main gray-level signal transmitted by the second data line.

The advantage of the method shown in FIG. 6 is similar to that of the method shown in FIG. 4, please refer to the description mentioned in the above embodiment.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A method of driving a pixel, characterized in that: the method comprises steps of:
(S1) converting one image signal of a frame to two image signals of the frame, and each of the two image signals comprising a main gray-level signal;
(S2) a main sub-pixel displaying the main gray-level signal of one of the two image signals, while a secondary sub-pixel displaying the main gray-level signal of the other image signal;
wherein when taking a pixel driven by a scan line and two data lines, each of the two image signals comprises a secondary gray-level signal, and a gray-level of the main gray-level signal is higher than that of the secondary gray-level signal; and the step S2 comprises the step of: transmitting the main grey-level signal and the secondary grey-level signal of one of the two image signals to the main sub-pixel and the secondary sub-pixel, respectively; transmitting the main grey-level signal and the secondary grey-level signal of the other image signal to the secondary sub-pixel and the main sub-pixel, respectively;
Wherein the time which the main sub-pixel displays main gray-level signal is equal to the time which the secondary sub-pixel displays secondary gray-level signal.

2. A method of driving a pixel, characterized in that: the method comprises steps of:
(S1) converting one image signal of a frame to two image signals of the frame, and each of the two image signals comprising a main gray-level signal;
(S2) a main sub-pixel displaying the main gray-level signal of one of the two image signals, while a secondary sub-pixel displaying the main gray-level signal of the other image signal.

3. The method of claim 2, characterized in that: when taking a pixel driven by a scan line and two data lines, each of the two image signals comprises a secondary gray-level signal, and a gray-level of the main gray-level signal is higher than that of the secondary gray-level signal;
and the step S2 comprises the step of: transmitting the main grey-level signal and the secondary grey-level signal of one of the two image signals to the main sub-pixel and the secondary sub-pixel, respectively; transmitting the main grey-level signal and the secondary grey-level signal of the other image signal to the secondary sub-pixel and the main sub-pixel, respectively.

4. The method of claim 2, characterized in that: the time which the main sub-pixel displays main gray-level signal is equal to the time which the secondary sub-pixel displays secondary gray-level signal.

5. The method of claim 2, characterized in that:
the step S1 comprises the step of converting the one image signal of the frame into a first image signal and a second image signal of the frame;
the step S2 comprises the step of the secondary sub-pixel displays the main gray-level signal during displaying the first image signal; the main sub-pixel displays the main gray-level signal during displaying the second image signal.

6. The method of claim 3, characterized in that:
the step S2 further comprises the step of: the main sub-pixel displays the secondary gray-level signal during displaying the first image signal; the secondary sub-pixel displays the secondary gray-level signal during displaying the second image signal.

7. The method of claim 6, characterized in that:
when the main sub-pixel is electrically coupled to the scan line and a first data line, and the secondary sub-pixel is electrically coupled to the scan line and a second data line, the step S2 comprises the steps of:
during displaying the first image signal, the main sub-pixel displays the secondary grey-level signal transmitted by the first data line, and the secondary sub-pixel displays the main gray-level signal transmitted by the second data line;
during displaying the second image signal, the main sub-pixel displays the main gray-level signal transmitted by the first data line, and the secondary sub-pixel displays the secondary gray-level signal transmitted by the second data line.

8. The method of claim 2, characterized in that:
the step S1 comprises the step of converting the one image signal of the frame into a first image signal and a second image signal of the frame;
the step S2 comprises the step of the secondary sub-pixel displays the main gray-level signal during displaying the second image signal; the main sub-pixel displays the main gray-level signal during displaying the first image signal.

9. The method of claim 3, characterized in that:
the step S2 further comprises the step of: the main sub-pixel displays the secondary gray-level signal during displaying the second image signal; the secondary sub-pixel displays the secondary gray-level signal during displaying the first image signal.

10. The method of claim 9, characterized in that:
when the main sub-pixel is electrically coupled to the scan line and a first data line, and the secondary sub-pixel is electrically coupled to the scan line and a second data line,
the step S2 comprises the steps of:
during displaying the first image signal, the main sub-pixel displays the main grey-level signal transmitted by the first data line, and the secondary sub-pixel displays the secondary gray-level signal transmitted by the second data line;
during displaying the second image signal, the main sub-pixel displays the secondary gray-level signal transmitted by the first data line, and the secondary sub-pixel displays the main gray-level signal transmitted by the second data line.

11. A pixel driving system characterized in that: the pixel driving system comprises:
a conversion module, for converting one image signal of a frame to two image signals of the frame, and each of the two image signals comprising a main gray-level signal; and
a display module, for displaying the main gray-level signal of one of the two image signals by using a main sub-pixel, while displaying the main gray-level signal of the other image signal by using a secondary sub-pixel.

12. The pixel driving system of claim 11, characterized in that: when taking a pixel driven by a scan line and two data lines, each of the two image signals comprises a secondary gray-level signal, and a gray-level of the main gray-level signal is higher than that of the secondary gray-level signal; and the display module is used for transmitting the main grey-level signal and the secondary grey-level signal of one of the two image signals to the main sub-pixel and the secondary sub-pixel, respectively, and for transmitting the main grey-level signal and the secondary grey-level signal of the other image signal to the secondary sub-pixel and the main sub-pixel, respectively.

13. The pixel driving system of claim 11, characterized in that: the time which the main sub-pixel displays main gray-level signal is equal to the time which the secondary sub-pixel displays secondary gray-level signal.
